(19) United States
(12) Patent Application Publication
(10) Pub. No.: US 2022/0058586 A1
(43) Pub. Date: Feb. 24, 2022

(54) In Advance Workforce Instant Wage Payment

(71) Applicant: ADP, LLC, Roseland, NJ (US)

(72) Inventors: Roberto Rodrigues Dias, Porto Alegre (BR); Victor de Almeida Piccoli Ferreira, Porto Alegre (BR); José Marcelo Kliemann, Porto Alegre (BR); Ernani Vinicius Thum, Porto Alegre (BR)

(21) Appl. No.: 16/997,012

(22) Filed: Aug. 19, 2020

(51) Int. Cl. G06Q 10/10; G06Q 40/00; G06Q 30/00; G06Q 10/06

(52) U.S. Cl. CPC G06Q 10/1053; G06Q 40/125; G06Q 30/0185; G06N 20/00; G06Q 10/063114; G06Q 10/1091; G06Q 2220/00; G06Q 10/1057

(57) ABSTRACT

Providing an in advance workforce instant wage payment to an employee is provided. A proportional wage payment amount for the employee is determined in accordance with a specified wage payment type for a current wage pay period based on collected work agreement information. A total wage compensation balance of the employee for the current wage pay period is adjusted by deducting the proportional wage payment amount in accordance with the specified wage payment type. An order for the proportional wage payment amount corresponding to the employee is transmitted to a specified wage payment proxy server via a network using a specified communication channel to pay the employee.

### BACKGROUND

### 1. Field

The disclosure relates generally to a gig economy and more specifically to providing in advance workforce instant wage payments to employees by determining a proportional wage payment amount for employees in accordance with specified wage payment types for a current wage pay period.

### 2. Description of the Related Art

A gig economy is a free market system in which temporary positions are common and employers, such as, for example, companies, organizations, agencies, institutions, and the like, hire workers for short-term commitments. The term “gig” is slang for a job that lasts a specified period of time (e.g., shift, day, week, month, three months, six months, per project, or the like). In the past, musicians were typically the ones who used the term gig to mean a job performing at a particular venue for a short time (e.g., a night, weekend, week, or the like). Now, a wide range of positions currently exist that fall into the category of a gig. For example, an adjunct or part-time professor is a contracted employee by an educational institution as opposed to a tenured or tenure-track professor.

Current estimates show as much as a third of the working population is already working in some type of gig capacity. This number is expected to rise, as these types of positions facilitate independent contracting work as many of these positions do not require the employee to physically come to a particular location (e.g., office building) to work. Thus, employers have a wider range of applicants to choose from as employers do not have to hire people based on a person's physical proximity to the employer.

In the gig economy, temporary, flexible jobs are commonplace and employers tend to hire independent contractors and freelancers instead of more permanent employees, such as full-time employees. Thus, the gig economy is in contrast to the traditional system of employment where full-time employees rarely change employers and focus on lifetime careers. In other words, the gig economy marks a recognizable shift from the traditional system of employment, where employees work for a single company over their entire tenure. In the gig economy, an employee may switch between roles and multiple (often simultaneous) positions of temporary work.

The gig economy often involves remote employees connecting with employers and their work assignments via a network or an online platform. For example, the modern digital world makes it increasingly common for people to work remotely (e.g., from home). As a result, the gig economy can benefit employees, employers, and consumers by making work more adaptable to the needs of the moment and the demand of flexible lifestyles.

Economic reasons also factor into the development of the gig economy. Many times, an employer cannot afford to hire full-time employees to do all the work that the employer needs to be performed, so the employer has to hire part-time or temporary employees to take care of busier times or specific projects. On the employee side, an employee may need to change geographic locations (e.g., due to family, health, and the like) or take multiple positions to afford the lifestyle the employee wants.

### SUMMARY

According to one illustrative embodiment, a computer-implemented method for providing an in advance workforce instant wage payment to an employee is provided. The computer determines a proportional wage payment amount for the employee in accordance with a specified wage payment type for a current wage pay period based on collected work agreement information. The computer adjusts a total wage compensation balance of the employee for the current wage pay period by deducting the proportional wage payment amount in accordance with the specified wage payment type. The computer transmits an order for the proportional wage payment amount corresponding to the employee to a specified wage payment proxy server via a network using a specified communication channel to pay the employee.

According to another illustrative embodiment, a computer system for providing an in advance workforce instant wage payment to an employee is provided. The computer system comprises a bus system, a storage device storing program instructions connected to the bus system, and a processor executing the program instructions connected to the bus system. The computer system determines a proportional wage payment amount for the employee in accordance with a specified wage payment type for a current wage pay period based on collected work agreement information. The computer system adjusts a total wage compensation balance of the employee for the current wage pay period by deducting the proportional wage payment amount in accordance with the specified wage payment type. The computer system transmits an order for the proportional wage payment amount corresponding to the employee to a specified wage payment proxy server via a network using a specified communication channel to pay the employee.

According to another illustrative embodiment, a computer program product for providing an in advance workforce instant wage payment to an employee is provided. The computer program product comprises a computer readable storage medium having program instructions embodied therewith, the program instructions executable by a computer to cause the computer to perform a method. The computer determines a proportional wage payment amount for the employee in accordance with a specified wage payment type for a current wage pay period based on collected work agreement information. The computer adjusts a total wage compensation balance of the employee for the current wage pay period by deducting the proportional wage payment amount in accordance with the specified wage payment type. The computer transmits an order for the proportional wage payment amount corresponding to the employee to a specified wage payment proxy server via a network using a specified communication channel to pay the employee.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented; and

FIGS. 3A-3B are a flowchart illustrating a process for providing an in advance workforce instant wage payment to an employee in accordance with an illustrative embodiment.

### DETAILED DESCRIPTION

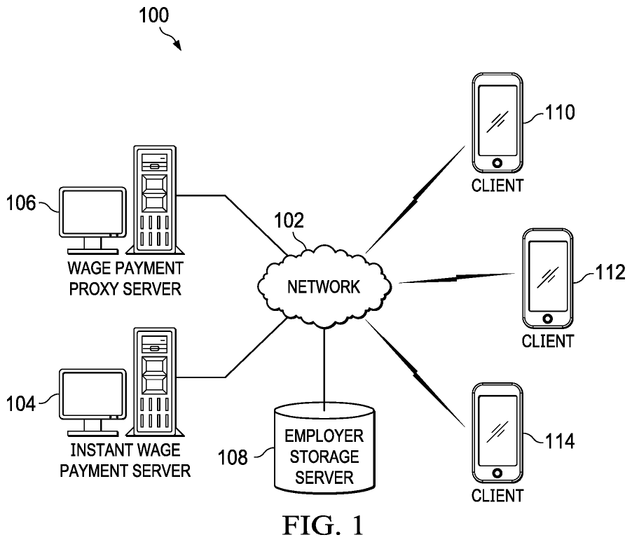

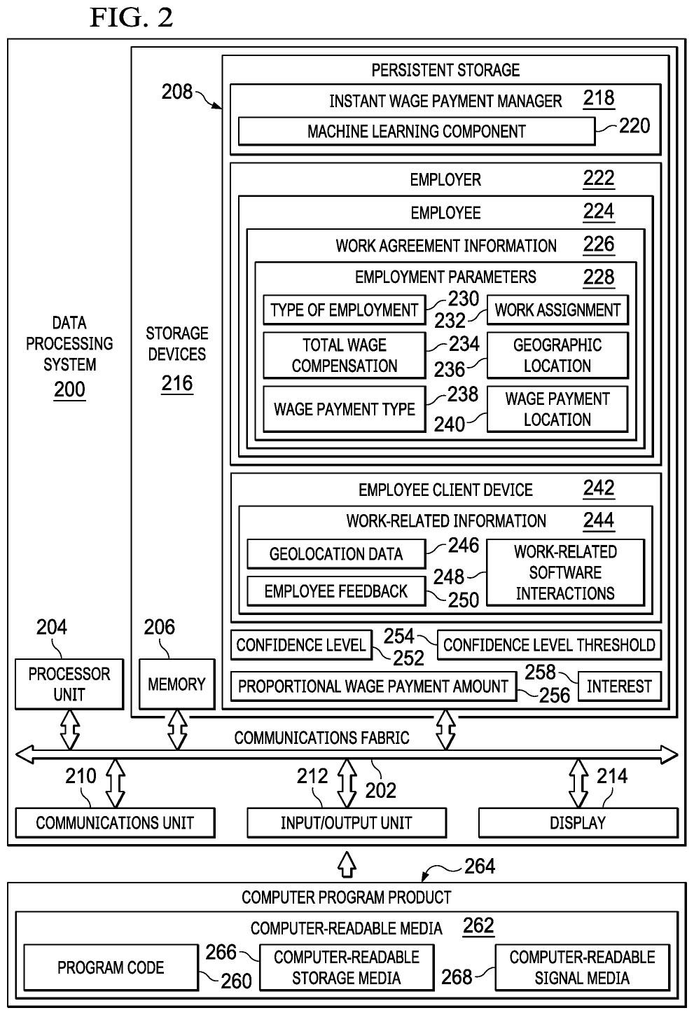

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, instant wage payment server 104 and wage payment proxy server 106 connect to network 102, along with employer storage server 108. Instant wage payment server 104, wage payment proxy server 106, and employer storage server 108 may be, for example, server computers with high-speed connections to network 102.

Instant wage payment server 104 provides in advance instant wage payment services to employees of one or more employers contracted or registered with the in advance instant wage payment services. Instant wage payment server 104 is owned or operated by an independent service provider, such as, for example, Automatic Data Processing, Inc. of New Jersey, which may provide the in advance instant wage payment services. It should be noted that instant wage payment server 104 may represent a cluster of servers in one or more data centers or, alternatively, may represent multiple computing nodes in one or more cloud environments.

Wage payment proxy server 106 may also represent a cluster of servers in one or more data centers or, alternatively, may represent multiple computing nodes in one or more cloud environments. Wage payment proxy server 106 provides real wage payments to the employees. Wage payment proxy server 106 is owned or operated by a wage payment proxy partner that was previously approved and is entrusted by the service provider of the in advance instant wage payment services to adhere to specified standards. The wage payment proxy partner may be, for example, a bank, a financial institution, a third-party wage payment business, the employer, or the like.

Instant wage payment server 104 transmits an order for an in advance instant wage payment corresponding to a particular employee during a current pay period to wage payment proxy server 106 to instantly provide the wage payment to that particular employee for a specified time period in advance of the end of the traditional pay period (e.g., weekly, biweekly, monthly, or the like). The in advance instant wage payment may be, for example: for a specified number of hours, such as 4, in one day; for a specified shift, such as a night shift, in one day; for a specified day, such as Wednesday, in one week; for a specified number of days, such as 3, in one week; for a specified week in one month; for a specified number of weeks, such as 2, in one month; or the like. Instant wage payment server 104 may also charge interest to an employer for making in advance instant wage payments to employees in advance of the end of traditional pay periods.

It should be noted that instant wage payment server 104 and wage payment proxy server 106 communicate with each other for each employee wage payment transaction using a specified communication channel, such as, for example, a specified application programming interface (API). The specified communication channel may transmit, for example, wage payment data, acknowledgements, confirmations, notifications, error messages, and the like. Further, the specified communication channel may be encrypted and adhere to specified standards, such as, for example, General Data Protection Regulation or the like, for data security.

Employer storage server 108 is a network storage device capable of storing any type of data in a structured format or an unstructured format. Employer storage server 108 may represent a plurality of network storage devices owned or operated by one or more employers. An employer may be, for example, a company, organization, enterprise, institution, agency, business, or the like, which employs a multitude of geographically distributed employees. Moreover, employer storage server 108 may store information, such as, for example, identifiers and network addresses for a plurality of different instant wage payment servers, identifiers and network addresses for a plurality of different wage payment proxy servers, identifiers and network addresses for a plurality of different client devices, identifiers for a plurality of different client device users, and the like. In addition, employer storage server 108 may store one or more lists of employees corresponding to the one or more employers, work agreement information that includes employment paraments corresponding to each respective employee in the employee lists, and the like. Employer storage server 108 may also store employee work-related data, files, applications, programs, and the like. Further, employer storage server 108 may store other data, such as authentication or credential data that may include user names, passwords, and biometric data associated with client device users and system administrators, for example.

Client 110, client 112, and client 114 also connect to network 102. Clients 110, 112, and 114 are clients of instant wage payment server 104, wage payment proxy server 106, and employer storage server 108. Clients 110, 112, and 114 are owned or operated by employees to perform assigned work-related activities. Further, it should be noted that an employee may own or operate a number of client devices to perform assigned work-related activities.

In this example, clients 110, 112, and 114 are shown as mobile devices, such as smart phones, with wireless communication links to network 102. However, it should be noted that clients 110, 112, and 114 are examples only and may represent other types of data processing systems, such as, for example, desktop or personal computers, laptop computers, handheld computers, smart televisions, and the like, with wire or wireless communication links to network 102. Employees corresponding to clients 110, 112, and 114 may utilize clients 110, 112, and 114 to access and utilize work-related data, files, applications, programs, and the like stored in employer storage server 108 to perform corresponding work-related activities.

Further, clients 110, 112, and 114, on a predetermined time interval basis, such as, for example, every 1, 5, 10, or 15 minutes, transmit work-related information to instant wage payment server 104 for analysis to determine a confidence level associated with performance of work-related activities by employees based on collected work-related information from clients 110, 112, and 114 and collected work agreement information from employer storage server 108 corresponding to each respective employee of clients 110, 112, and 114. The collected work-related information from clients 110, 112, and 114 may include, for example: geolocation data, such as GPS coordinates, identifying where work-related activities are being performed by employees; number of software interactions with work-related software, such as applications, spreadsheets, programs, and the like, identifying an amount of time spent by employees on the work-related activities; employee feedback regarding confirmation of the geolocation data and software interactions when inconsistencies exist with machine learning data; and the like. The collected work agreement information may include, for example: type of employment, such as full-time, part-time, or gig employee; work assignments; total wage compensation for a traditional pay period, such as weekly, biweekly, or monthly; geographic location of where work-related activities are to be performed by respective employees; wage payment type, such as a traditional wage payment type or an in advance instant wage payment type; monitoring tasks, such as employee location and work-related activity tracking; employee benefits, such as vacation time and sick leave; and the like. Instant wage payment server 104 may utilize, for example, a machine learning component to perform the analysis of the collected information to determine the confidence level associated with the work-related activities performed by each respective employee. The machine learning component learns the work patterns, such as, for example, work location, work days, time spent working each day, and the like, of each respective employee overtime. As a result, the machine learning component is able to detect when a particular employee is not spending time working, such as, for example, traveling to and from a work location, at lunch, on vacation, and the like.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on instant wage payment server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), a telecommunications network, or any combination thereof. FIG. 1 is intended as an example only, and not as an architectural limitation for the different illustrative embodiments.

As used herein, when used with reference to items, “a number of” means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

With reference now to FIG. 2, a diagram of a data processing system is depicted in accordance with an illustrative embodiment. Data processing system 200 is an example of a computer, such as instant wage payment server 104 in FIG. 1, in which computer readable program code or instructions implementing the in advance instant wage payment processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer readable storage device or computer readable storage medium is any piece of hardware that is capable of storing information, such as, for example, without limitation, data, computer readable program instructions in functional form, and/or other suitable information either on a transient basis or a persistent basis. Further, a computer readable storage device or computer readable storage medium excludes a propagation medium, such as a transitory signal. Memory 206, in these examples, may be, for example, a random-access memory (RAM), or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores instant wage payment manager 218. However, it should be noted that even though instant wage payment manager 218 is illustrated as residing in persistent storage 208, in an alternative illustrative embodiment instant wage payment manager 218 may be a separate component of data processing system 200. For example, instant wage payment manager 218 may be a hardware component coupled to communication fabric 202 or a combination of hardware and software components. In another alternative illustrative embodiment, a first set of components of instant wage payment manager 218 may be located in data processing system 200 and a second set of components of instant wage payment manager 218 may be located in a second data processing system, such as, for example, a second instant wage payment server.

Instant wage payment manager 218 controls the process of providing in advance workforce instant wage payments to employees by determining a proportional wage payment amount for employees in accordance with specified wage payment types for a current wage pay period. In this example, instant wage payment manager 218 includes machine learning component 220. Machine learning component 220 may be, for example, an artificial intelligence application capable of natural language processing, statistical analysis, and the like.

Employer 222 represents an identifier of a particular employer employing a multitude of geographically distributed employees. Employer 222 may be, for example, a company, business, enterprise, organization, institution, agency, or the like. It should be noted that employer 222 may also represent a number of employers.

Employee 224 represents an identifier of a particular employee of employer 222. Employee 224 may be, for example, a worker, a manager, an executive, an officer, or the like. In addition, employee 224 may represent an identifier for each respective employee in the multitude of geographically distributed employees corresponding to employer 222.

Work agreement information 226 corresponds to employee 224. Instant wage payment manager 218 collects work agreement information 226 from a storage server corresponding to employer 222, such as, for example, employer storage server 108 in FIG. 1. Work agreement information 226 includes employment parameters 228 corresponding to employee 224. In this example, employment parameters 228 include type of employment 230, work assignment 232, total wage compensation 234, geographic location 236, wage payment type 238, and wage payment location 240. However, it should be noted that employment parameters 228 may include more information, such as employee monitoring tasks and employee benefits, or less information than shown.

Type of employment 230 identifies whether employee 224 is a full-time employee, part-time employee, gig employee, or the like of employer 222. A gig employee may be, for example, a contract employee, a freelance employee, or the like.

Work assignment 232 identifies the type of work assigned to employee 224 by employer 224. The type of work may be, for example, assignment to a set of one or more projects as a contributor, editor, manager, or the like.

Total wage compensation 234 identifies a total amount of pay employee 224 is entitled to receive for performing work assignment 232 during a traditional pay period of employer 222. A traditional pay period may be, for example, weekly, biweekly, monthly, or the like.

Geographic location 236 identifies a particular geographic location where employee 224 is to perform work-related activities corresponding to work assignment 232. The particular geographic location may be, for example, a home office or particular room located in a residence corresponding to employee 224. Alternatively, the particular geographic location may be an assigned office space or work area located in a building owned or operated by employer 222 or some other third-party building owner or operator.

Wage payment type 238 identifies the category or variety of wage payment that instant wage payment manager 218 is to utilize when calculating employee 224's pay. Wage payment type 238 may be a traditional wage payment where employee 224 receives payment at the end of each traditional pay period of employer 222 (e.g., each week, every two weeks, or once a month). Alternatively, wage payment type 238 may be an in advance instant wage payment where employee 224 receives payment prior to the end of the traditional pay period of the employer 222. For example, employee 224 may have contracted with employer 222 to receive wages for completed work for a specified period of time, such as after a defined number of hours, at the end of a shift, at close of each business day, or the like.

Wage payment location 240 identifies where instant wage payment manager 218 is to send an order for real payment of wages corresponding to employee 224. The location to send the order for real payment may be, for example, a wage payment proxy server, such as wage payment proxy server 106 in FIG. 1, that corresponds to a wage payment proxy partner, such as a bank. It should be noted that instant wage payment manager 218 communicates with the wage payment proxy server via a specified communication channel, such as a specified API, which is a secure communication channel (e.g., data encrypted).

Employee client device 242 identifies a client device, such as client 110 in FIG. 1, which corresponds to employee 224. Employee 224 utilizes employee client device 242 to perform work-related activities corresponding to work assignment 232. It should be noted that employee client device 242 is configured to transmit work-related information 244 to instant wage payment manager 218 on a predetermined time interval basis, such as, for example, once every minute, five minutes, ten minutes, thirty minutes, hour, or the like. Instant wage payment manager 218 utilizes work-related information 244 to increase wage payment security and decrease employee wage payment fraud.

In this example, work-related information 244 includes geolocation data 246, work-related software interactions 248, and employee feedback 250. Geolocation data 246 may be, for example, GPS coordinates that identify a current location of employee client device 242. Work-related software interactions 248 identify which work-related software, such as applications or programs, employee 224 is interacting with on employee client device 242 to perform work-related activities corresponding to work assignment 232 during identified work times, such as, for example, between the hours of 9:00 a.m. to 12:00 p.m. and 12:30 p.m. to 5:00 p.m. each week day. Employee feedback 250 represents input or responses to instant wage payment manager 218 by employee 224 regarding accuracy of geolocation data 246 and work-related software interactions 248. Instant wage payment manager 218 may request employee feedback 250 from employee 224 when confidence level 252 is not greater than or equal to confidence level threshold 254 or when inconsistencies or outliers exist. Confidence level threshold 254 may be, for example, a 90% confidence level threshold. However, confidence level threshold 254 may be any predefined threshold level, such as, for example, 75%, 80%, 85%, 90%, 95%, 98%, or the like.

Instant wage payment manager 218 utilizes machine learning component 220 to calculate confidence level 252 based on collected work agreement information 226 and work-related information 244 corresponding to employee 224 for a current pay period. Confidence level 252 identifies a degree of assurance or certainty regarding performance of work-related activities by employee 224 in relation to work assignment 232 during the current pay period. In other words, confidence level 252 verifies eligibility of employee 224 to receive a certain amount of wage payment for the current pay period.

If instant wage payment manager 218 determines that confidence level 252 for the current pay period is greater than or equal to confidence level threshold 254, then instant wage payment manager 218 calculates proportional wage payment amount 256. Proportional wage payment amount 256 may be, for example, a proportional wage payment amount per hour, a proportional wage payment amount per day, a proportional wage payment amount per week, a proportional wage payment amount per month, or the like. In other words, proportional wage payment amount 256 may represent all or a portion of total wage compensation 234 for the current pay period.

If proportional wage payment amount 256 represents all of total wage compensation 234 for the current pay period, then proportional wage payment amount 256 represents a traditional wage payment to employee 224 at an end of the traditional pay period (e.g., at the end of a two week pay cycle or at an end of a monthly pay cycle). If proportional wage payment amount 256 represents a portion of total wage compensation 234 for the current pay period, such as wages for a single day's work, then proportional wage payment amount 256 represents an in advance instant wage payment to employee 224 prior to the end of the traditional pay period. If proportional wage payment amount 256 represents an in advance instant wage payment prior to the end of the traditional pay period, then instant wage payment manager 218 may calculate an amount of interest 258 to charge employer 222 for the in advance instant wage payment to employee 224 prior to the end of the traditional pay period. In addition, instant wage payment manager 218 adjusts total wage compensation 234 for the current pay period by subtracting proportional wage payment amount 256 from total wage compensation 234 for the current pay period.

As a result, data processing system 200 operates as a special purpose computer system in which instant wage payment manager 218 in data processing system 200 enables in advance workforce instant wage payments to employees prior to a current traditional pay period ending. In particular, instant wage payment manager 218 transforms data processing system 200 into a special purpose computer system as compared to currently available general computer systems that do not have instant wage payment manager 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 260 is located in a functional form on computer readable media 262 that is selectively removable and may be loaded onto or transferred to data processing system 200 for running by processor unit 204. Program code 260 and computer readable media 262 form computer program product 264. In one example, computer readable media 262 may be computer readable storage media 266 or computer readable signal media 268.

In these illustrative examples, computer readable storage media 266 is a physical or tangible storage device used to store program code 260 rather than a medium that propagates or transmits program code 260. In other words, computer readable storage media 266 exclude a propagation medium, such as transitory signals. Computer readable storage media 266 may include, for example, an optical or magnetic disc that is inserted or placed into a drive or other device that is part of persistent storage 208 for transfer onto a storage device, such as a hard drive, that is part of persistent storage 208. Computer readable storage media 266 also may take the form of a persistent storage, such as a hard drive, a thumb drive, or a flash memory that is connected to data processing system 200.

Alternatively, program code 260 may be transferred to data processing system 200 using computer readable signal media 268. Computer readable signal media 268 may be, for example, a propagated data signal containing program code 260. For example, computer readable signal media 268 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer readable media 262” can be singular or plural. For example, program code 260 can be located in computer readable media 262 in the form of a single storage device or system. In another example, program code 260 can be located in computer readable media 262 that is distributed in multiple data processing systems. In other words, some instructions in program code 260 can be located in one data processing system while other instructions in program code 260 can be located in one or more other data processing systems. For example, a portion of program code 260 can be located in computer readable media 262 in a server computer while another portion of program code 260 can be located in computer readable media 262 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 260.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

Illustrative embodiments take into account and address the current trend, influenced by the gig economy, where employees increasingly desire to receive instant wage payments for completed work on an hourly or daily basis, for example, instead of traditional weekly, bi-weekly, or monthly payments. Providing flexible payment methods is a creative way for employers to attract and retain gig employees. Flexible payments may encourage gig employees to apply for open positions, timely engage with work assignments, and feel empowered during their term of employment. However, many employers may not be financially prepared to provide these instant wage payments to employees without a full restructuring of their financial models.

Illustrative embodiments provide in advance workforce instant wage payments, which enable employers (e.g., companies) to give their employees the benefit of receiving instant payments (e.g., hourly, per shift, daily, and the like) without the need of employers having the financial resources available at the moment of the instant payments. Further, employers need not change their current payment cycles (e.g., monthly or bi-weekly payment cycles) to the service provider providing the in advance workforce instant wage payments of illustrative embodiments. The in advance workforce instant wage payments of illustrative embodiments is based on an employer's post-paid payroll contract, where the service provider charges interest to an employer on each instant payment made to an employee of the contracted employer.

For example, the service provider providing the instant wage payment service of illustrative embodiments charges a contracted interest rate (e.g., the current federal interest rate) for loaning these instant wage payments to specific employees in advance of the traditional payment process. However, the traditional payment process to other employees may remain unchanged. For any wage payments made using the in advance instant wage payment service of illustrative embodiments, the service provider creates a new wage payment cycle and operates as a loan agent charging interest to the employer on any instant wage payments made between traditional wage payment cycles. Thus, illustrative embodiments make little to no impact on current payroll contracts between the service provider and employers, except for charging interest when certain employees opt-in to the in advance instant wage payment service provided by illustrative embodiments. As a result, illustrative embodiments are capable of providing in advance instant wage payments to a workforce comprising a multitude of geographically distributed employees on an on-demand, real time basis, which cannot be performed by a manual process.

Illustrative embodiments provide an instant wage payment platform (e.g., server or set of servers) that supports the implementation of the in advance instant wage payments (e.g., hourly, daily, and the like) to employees of registered employers with the in advance instant wage payment service. Illustrative embodiments base instant wage payments on defined parameters within an employee work agreement (e.g., an employment contract) corresponding to a particular employee and also utilize machine learning techniques, such as, for example, artificial intelligence, regression, outlier detection, deep learning, data analysis, data visualization, data mining, supervised learning, semi-supervised learning, unsupervised learning, reinforcement learning, statistical analysis, natural language processing, and the like, to effectively predict with a predefined level of confidence whether that particular employee is working defined hours at a specified geographic location to generate the expected proportional instant wage payment order. In other words, illustrative embodiments calculate the proportional instant wage payment for only that which the employee is entitled to (i.e., the amount of work performed at the defined geographic location for the specified time period (e.g., 8 hours). As a result, illustrative embodiments increase security of the instant wage payments by decreasing wage payment fraud.

It should be noted that illustrative embodiments provide an employer interface, such as a web-based application, and an employee interface, such as a mobile application. The employer interface may provide information, such as, for example, employee work agreements, employee monitoring tasks to be performed, employee wage payment types (e.g., traditional or instant wage payment), identification of where to send employee wage payments, and the like, to the instant wage payment server. The employee interface may provide information, such as, for example, geolocation data corresponding to an employee performing work assignments, responses to information requests (e.g., employee feedback), work-related software interactions by the employee, and the like, to the instant wage payment server. Illustrative embodiments also connect via specified application programming interfaces to other payment entities, such as, for example, banks or other third-party financial institutions, in order to realize real proportional instant wage payments to employees or just return the expected proportional instant wage payment order to the employer to pay the employee directly.

Thus, illustrative embodiments provide one or more technical solutions that overcome a technical problem with providing a secure way to determine and pay a multitude of geographically distributed employees instantly in advance of an end of an employer's traditional wage payment cycle, while preventing employee wage fraud. As a result, these one or more technical solutions provide a technical effect and practical application in the field of electronic wage payment security via a network.

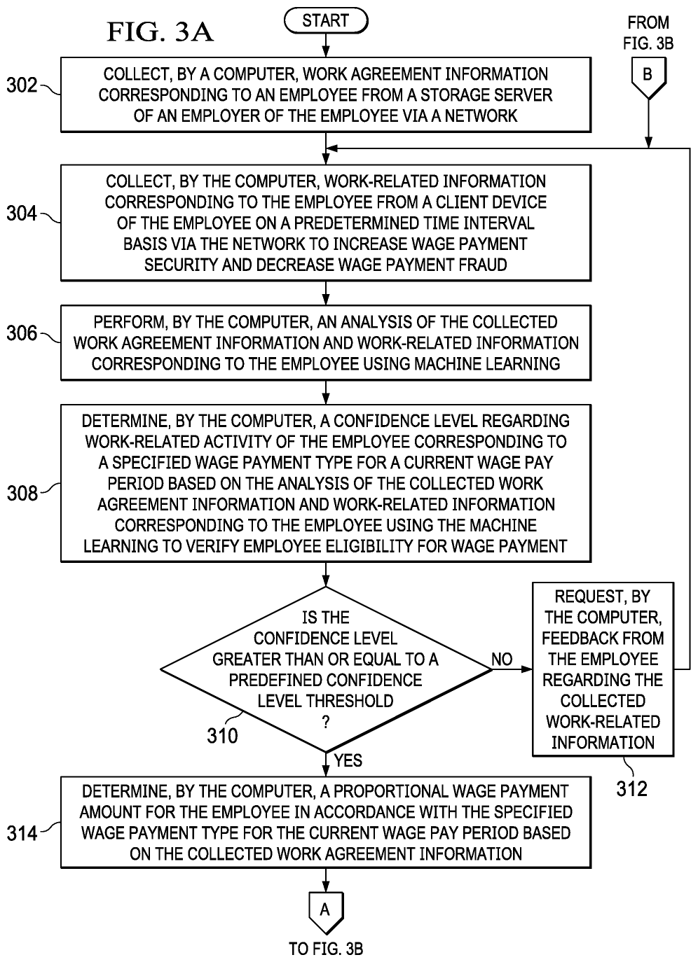

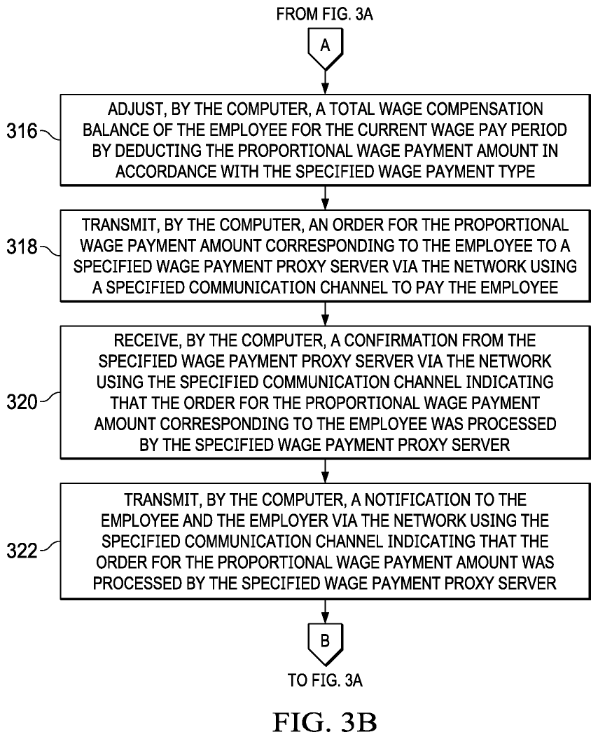

With reference now to FIGS. 3A-3B, a flowchart illustrating a process for providing an in advance workforce instant wage payment to an employee is shown in accordance with an illustrative embodiment. The process shown in FIGS. 3A-3B may be implemented in a computer, such as, for example, instant wage payment server 104 in FIG. 1 or data processing system 200 in FIG. 2. For example, the process can be implemented in instant wage payment manager 218 in FIG. 2.

The process begins when the computer collects work agreement information corresponding to the employee from a storage server of an employer of the employee via a network (step 302). In addition, the computer collects work-related information corresponding to the employee from a client device of the employee on a predetermined time interval basis via the network to increase wage payment security and decrease wage payment fraud (step 304). Further, the computer performs an analysis of the collected work agreement information and the collected work-related information corresponding to the employee using machine learning (step 306).

Afterward, the computer determines a confidence level regarding work-related activity of the employee corresponding to a specified wage payment type for a current wage pay period based on the analysis of the collected work agreement information and work-related information corresponding to the employee using the machine learning to verify employee eligibility for wage payment (step 308). The computer makes a determination as to whether the confidence level is greater than or equal to a predefined confidence level threshold (step 310).

If the computer determines that the confidence level is less than the predefined confidence level threshold, no output of step 310, then the computer requests feedback from the employee regarding the collected work-related information (step 312). Thereafter, the process returns to step 304 where the computer continues to collect work-related information, which includes the employee feedback, corresponding to the employee from the client device. If the computer determines that the confidence level is greater than or equal to the predefined confidence level threshold, yes output of step 310, then the computer determines a proportional wage payment amount for the employee in accordance with the specified wage payment type for the current wage pay period based on the collected work agreement information (step 314).

Subsequently, the computer adjusts a total wage compensation balance of the employee for the current wage pay period by deducting the proportional wage payment amount in accordance with the specified wage payment type (step 316). The computer transmits an order for the proportional wage payment amount corresponding to the employee to a specified wage payment proxy server via the network using a specified communication channel to pay the employee (step 318).

Afterward, the computer receives a confirmation from the specified wage payment proxy server via the network using the specified communication channel indicating that the order for the proportional wage payment amount corresponding to the employee was processed by the specified wage payment proxy server (step 320). Further, the computer transmits a notification to the employee and the employer via the network using the specified communication channel indicating that the order for the proportional wage payment amount was processed by the specified wage payment proxy server (step 322). Thereafter, the process returns to step 304 where the computer continues to collect work-related information corresponding to the employee from the client device.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

Thus, illustrative embodiments of the present invention provide a computer-implemented method, computer system, and computer program product for providing in advance workforce instant wage payments to employees by determining a proportional wage payment amount for employees in accordance with specified wage payment types for a current wage pay period. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for providing an in advance workforce instant wage payment to an employee, the computer-implemented method comprising:
determining, by a computer, a proportional wage payment amount for the employee in accordance with a specified wage payment type for a current wage pay period based on collected work agreement information;
adjusting, by the computer, a total wage compensation balance of the employee for the current wage pay period by deducting the proportional wage payment amount in accordance with the specified wage payment type; and
transmitting, by the computer, an order for the proportional wage payment amount corresponding to the employee to a specified wage payment proxy server via a network using a specified communication channel to pay the employee.

2. The computer-implemented method of claim 1 further comprising:
collecting, by the computer, work agreement information corresponding to the employee from a storage server of an employer of the employee via a network; and
collecting, by the computer, work-related information corresponding to the employee from a client device of the employee on a predetermined time interval basis via the network to increase wage payment security and decrease wage payment fraud.

3. The computer-implemented method of claim 2 further comprising:
performing, by the computer, an analysis of the collected work agreement information and the collected work-related information corresponding to the employee using machine learning;
determining, by the computer, a confidence level regarding work-related activity of the employee corresponding to the specified wage payment type for the current wage pay period based on the analysis of the collected work agreement information and the collected work-related information corresponding to the employee using the machine learning to verify employee eligibility for wage payment; and
determining, by the computer, whether the confidence level is greater than or equal to a predefined confidence level threshold.

4. The computer-implemented method of claim 3 further comprising:
responsive to the computer determining that the confidence level is less than the predefined confidence level threshold, requesting, by the computer, feedback from the employee regarding the collected work-related information.

5. The computer-implemented method of claim 3 further comprising:
responsive to the computer determining that the confidence level is greater than or equal to the predefined confidence level threshold, determining, by the computer, the proportional wage payment amount for the employee in accordance with the specified wage payment type for the current wage pay period based on the collected work agreement information.

6. The computer-implemented method of claim 1 further comprising:
receiving, by the computer, a confirmation from the specified wage payment proxy server via the network using the specified communication channel indicating that the order for the proportional wage payment amount corresponding to the employee was processed by the specified wage payment proxy server.

7. The computer-implemented method of claim 1 further comprising:
transmitting, by the computer, a notification to the employee and an employer of the employee via the network using the specified communication channel indicating that the order for the proportional wage payment amount was processed by the specified wage payment proxy server.

8. The computer-implemented method of claim 1, wherein the specified communication channel is encrypted and adheres to specified standards for data security.

9. The computer-implemented method of claim 1, wherein the collected work agreement information comprises at least one of type of employment, work assignment, total wage compensation for a traditional pay period, geographic location of where work-related activities are to be performed by the employee, wage payment type, employee monitoring tasks, and employee benefits, and wherein the wage payment type is one of a traditional wage payment type and an in advance instant wage payment type.

10. The computer-implemented method of claim 1, wherein collected work-related information from a client device of the employee on a predetermined time interval basis comprises at least one of geolocation data identify where work-related activities are being performed by the employee, number of software interactions with work-related software identifying an amount of time spent by the employee on the work-related activities, and employee feedback regarding confirmation of the geolocation data and software interactions when inconsistencies exist with machine learning data.

11. The computer-implemented method of claim 1, wherein the proportional wage payment amount is one of a proportional wage payment amount per hour, a proportional wage payment amount per day, a proportional wage payment amount per week, and a proportional wage payment amount per month, and wherein when the proportional wage payment amount is a portion of the total wage compensation balance for the current wage pay period, the proportional wage payment amount is an in advance instant wage payment to the employee prior to an end of a traditional pay period.

12. A computer system for providing an in advance workforce instant wage payment to an employee, the computer system comprising:
a bus system;
a storage device connected to the bus system, wherein the storage device stores program instructions; and
a processor connected to the bus system, wherein the processor executes the program instructions to:
determine a proportional wage payment amount for the employee in accordance with a specified wage payment type for a current wage pay period based on collected work agreement information;
adjust a total wage compensation balance of the employee for the current wage pay period by deducting the proportional wage payment amount in accordance with the specified wage payment type; and
transmit an order for the proportional wage payment amount corresponding to the employee to a specified wage payment proxy server via a network using a specified communication channel to pay the employee.

13. The computer system of claim 12, wherein the processor further executes the program instructions to:
collect work agreement information corresponding to the employee from a storage server of an employer of the employee via a network; and
collect work-related information corresponding to the employee from a client device of the employee on a predetermined time interval basis via the network to increase wage payment security and decrease wage payment fraud.

14. The computer system of claim 13, wherein the processor further executes the program instructions to:
perform an analysis of the collected work agreement information and the collected work-related information corresponding to the employee using machine learning;
determine a confidence level regarding work-related activity of the employee corresponding to the specified wage payment type for the current wage pay period based on the analysis of the collected work agreement information and the collected work-related information corresponding to the employee using the machine learning to verify employee eligibility for wage payment; and
determine whether the confidence level is greater than or equal to a predefined confidence level threshold.

15. A computer program product for providing an in advance workforce instant wage payment to an employee, the computer program product comprising a computer readable storage medium having program instructions embodied therewith, the program instructions executable by a computer to cause the computer to perform a method of:
determining, by the computer, a proportional wage payment amount for the employee in accordance with a specified wage payment type for a current wage pay period based on collected work agreement information;
adjusting, by the computer, a total wage compensation balance of the employee for the current wage pay period by deducting the proportional wage payment amount in accordance with the specified wage payment type; and
transmitting, by the computer, an order for the proportional wage payment amount corresponding to the employee to a specified wage payment proxy server via a network using a specified communication channel to pay the employee.

16. The computer program product of claim 15 further comprising:
collecting, by the computer, work agreement information corresponding to the employee from a storage server of an employer of the employee via a network; and
collecting, by the computer, work-related information corresponding to the employee from a client device of the employee on a predetermined time interval basis via the network to increase wage payment security and decrease wage payment fraud.

17. The computer program product of claim 16 further comprising:
performing, by the computer, an analysis of the collected work agreement information and the collected work-related information corresponding to the employee using machine learning;
determining, by the computer, a confidence level regarding work-related activity of the employee corresponding to the specified wage payment type for the current wage pay period based on the analysis of the collected work agreement information and the collected work-related information corresponding to the employee using the machine learning to verify employee eligibility for wage payment; and
determining, by the computer, whether the confidence level is greater than or equal to a predefined confidence level threshold.

18. The computer program product of claim 17 further comprising:
responsive to the computer determining that the confidence level is less than the predefined confidence level threshold, requesting, by the computer, feedback from the employee regarding the collected work-related information.

19. The computer program product of claim 17 further comprising:
responsive to the computer determining that the confidence level is greater than or equal to the predefined confidence level threshold, determining, by the computer, the proportional wage payment amount for the employee in accordance with the specified wage payment type for the current wage pay period based on the collected work agreement information.

20. The computer program product of claim 15 further comprising:
receiving, by the computer, a confirmation from the specified wage payment proxy server via the network using the specified communication channel indicating that the order for the proportional wage payment amount corresponding to the employee was processed by the specified wage payment proxy server.
